(19) United States
(12) Patent Application Publication
(10) Pub. No.: US 2025/0325343 A1
(43) Pub. Date: Oct. 23, 2025

(54) ORAL IRRIGATOR

(71) Applicant: GUANGZHOU STARS PULSE CO.,LTD., GUANGZHOU (CN)

(72) Inventor: SHIHUA LIU, GUANGZHOU (CN)

(21) Appl. No.: 18/923,874

(22) Filed: Oct. 23, 2024

(30) Foreign Application Priority Data
Apr. 19, 2024 (CN) 202420835343.9

(51) Int. Cl. A61C 1/00

(52) U.S. Cl. CPC A61C 1/0084

(57) ABSTRACT

An oral irrigator includes a main body and a water tank connected to the main body. At least one first magnetic piece is disposed on the main body. The water tank defines a water storage space or the water tank and the main body jointly define the water storage space. At least one second magnetic piece is disposed on the water tank. The at least one first magnetic piece is magnetically connected to the at least one second magnetic piece to generate a magnetic attraction force. A sum of a gravity of the water tank and a gravity of a liquid fully filled in the water storage space is less than the magnetic attraction force. The water tank and the main body are not separated from each other under an action of gravity through the magnetic attraction force.

### TECHNICAL FIELD

The present disclosure relates to a technical field of oral cleaning equipment, and in particular to an oral irrigator.

### BACKGROUND

A portable oral irrigator in the related art commonly comprises a water tank and a main body. The water tank is detachably connected to the main body. There are generally two different connecting method for the water tank and the main body. In a first connecting method, a volume of the water tank is fixed, and the water tank and the main body are connected by snapping structures or clamping structures. In a second connecting method, the water tank is slidably connected to the main body to change a volume of a water storage cavity thereof. However, in the above two connecting methods, the user needs to manually align the water tank and the main body during an assembling process, which is inconvenient to assemble.

### SUMMARY

The present disclosure provides an oral irrigator that realizes a positioning and a connection between a main body and a water tank thereof through magnetic pieces without manual positioning, which is easy to assemble.

In a first aspect, the present disclosure provides an oral irrigator. The oral irrigator comprises a main body and a water tank connected to the main body. At least one first magnetic piece is disposed on the main body. The water tank defines a water storage space or the water tank and the main body jointly define the water storage space. At least one second magnetic piece is disposed on the water tank. The at least one first magnetic piece is magnetically connected to the at least one second magnetic piece to generate a magnetic attraction force. A sum of a gravity of the water tank and a gravity of a liquid fully filled in the water storage space is less than the magnetic attraction force, and the water tank and the main body are not separated from each other under an action of gravity through the magnetic attraction force.

In a second aspect, the present disclosure provides an oral irrigator. The oral irrigator comprises a main body and a water tank connected to the main body. At least one first magnetic piece is disposed on the main body. At least one second magnetic piece is disposed on the water tank. The at least one first magnetic piece is magnetically connected to the at least one second magnetic piece to generate a magnetic attraction force. A relative position between the main body and the water tank is predetermined. The magnetic attraction force generated by the at least one first magnetic piece and the at least one second magnetic piece keeps the relative position between the main body and the water tank being unchanged.

In the oral irrigator of embodiments of the present disclosure, by providing the at least one first magnetic piece and the at least one second magnetic pieces, during an assembling process of the oral irrigator, the magnetic attraction force guides the water tank and the main body, so the water tank and the main body are automatically positioned and connected without a need for manual alignment by a user, making the assembling process convenient. Moreover, the magnetic attraction force between the at least one first magnetic piece and the at least one second magnetic piece prevents the water tank and the main body from separating, so that the water tank is stably connected to the main body.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a structural schematic diagram of an oral irrigator according to a first embodiment of the present disclosure.

FIG. 2 is a cross-sectional schematic diagram of the oral irrigator according to the first embodiment of the present disclosure.

FIG. 3 is an enlarged schematic diagram of area A shown in FIG. 2.

FIG. 4 is a structural schematic diagram of a water tank of the oral irrigator according to the first embodiment of the present disclosure.

FIG. 5 is a cross-sectional schematic diagram of the water tank of the oral irrigator according to the first embodiment of the present disclosure.

FIG. 6 is a structural schematic diagram of the water tank, connected to second magnetic pieces of the oral irrigator according to the first embodiment of the present disclosure.

FIG. 7 is a structural schematic diagram of a main body of the oral irrigator according to the first embodiment of the present disclosure.

FIG. 8 is an enlarged schematic diagram of area B shown in FIG. 2.

FIG. 9 is a structural schematic diagram of the oral irrigator according to a second embodiment of the present disclosure.

FIG. 10 is a structural schematic diagram of the oral irrigator according to a third embodiment of the present disclosure.

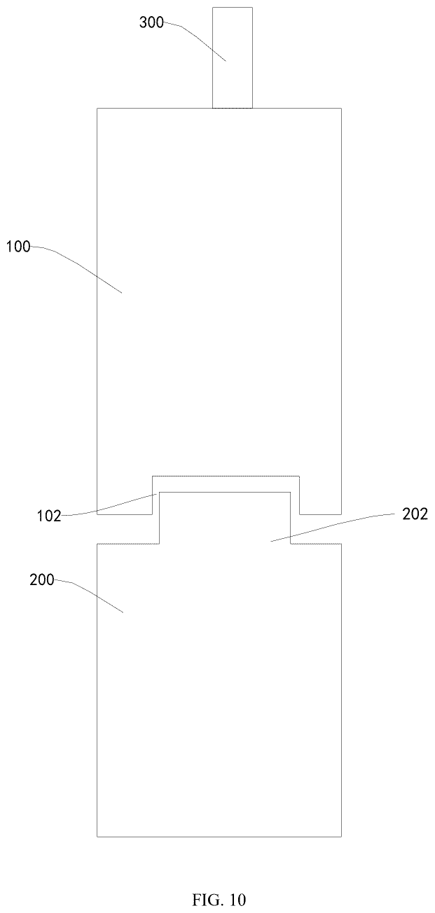

FIG. 11 is a structural schematic diagram of the oral irrigator according to a fourth embodiment of the present disclosure.

Reference numbers in the drawings:

Oral irrigator 1; main body 100; first magnetic piece 101; recess 102; first communicating opening 105; abutting piece 106; motor 107; pump 110; control circuit board 120; water tank 200; second magnetic piece 201; protrusion 202; second cover 203; second mounting groove 204; second communicating opening 205; valve 207; water storage space 208; sealing piece 210; first sealing protrusion 211; second sealing protrusion 212; nozzle 300; operation module 500.

The purpose, features, and characteristics of the present disclosure are further described in conjunction with the embodiments and with reference to the accompanying drawings.

### DETAILED DESCRIPTION

The following section will further describe the embodiments of the present disclosure in detail with reference to the accompanying drawings.

When the following description refers to the drawings, the same numbers in different drawings refer to the same or similar elements unless otherwise indicated.

It should be understood in the description of the present disclosure that terms such as “first” and “second” are only used for the purpose of description, rather than being understood to indicate or imply relative importance or hint the number of indicated technical features. Thus, the feature limited by “first” and “second” can explicitly or impliedly include at least one feature. Unless otherwise indicated, the term “a plurality of” means two or more. The term “and/or” depict relationship between associated objects and there are three relationships thereon. For example, A and/or B may indicate A exists alone, A and B exist at the same time, and B exists alone. The character “/” generally indicates that the associated object is alternative. The terms “first”, “second”, “third”, etc. in the present disclosure are used only to distinguish similar objects and do not imply a specific ordering of objects.

Unless otherwise defined, all technical and scientific terms used herein have the same meaning as commonly understood by those skilled in the art of the present disclosure. The terminology used in the specification is for describing specific embodiments only and is not intended to limit the present disclosure.

The oral irrigator 1 according to embodiments of the present disclosure is described below with reference to the accompanying drawings.

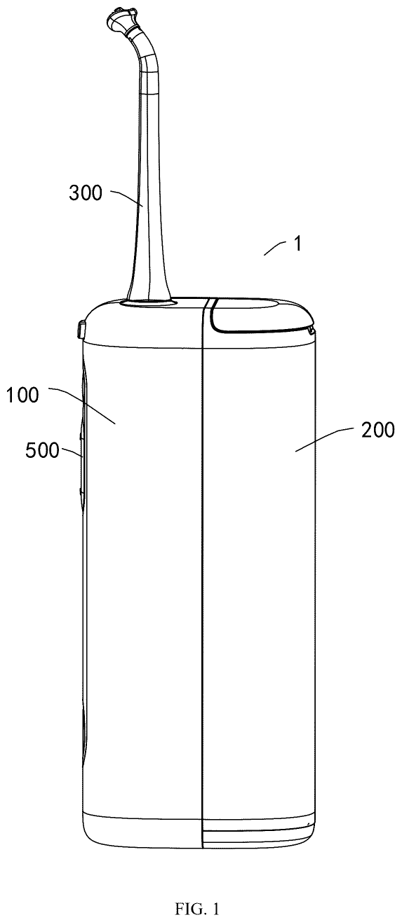

As shown in FIGS. 1-3, the present disclosure provides the oral irrigator 1. The oral irrigator 1 comprises a main body 100 and a water tank 200.

At least one first magnetic piece 101 is disposed on the main body 100. The water tank 200 is connected to the main body 100. For instance, the water tank is connected to an end portion of the main body 100 or one side of the main body 100 facing the water tank 200. The water tank 200 defines a water storage space 208 or the water tank 200 and the main body 100 jointly define the water storage space 208. The water storage space 208 is configured to store liquid for cleaning an oral cavity, such as water or mouthwash. At least one second magnetic piece 201 is disposed on the water tank 200. The at least one first magnetic piece 101 is magnetically connected to the at least one second magnetic piece 201.

Optionally, the at least one first magnetic piece 101 may be a first permanent magnet, such as a first magnet, and the at least one second magnetic piece 201 maybe a second permanent magnet, such as a second magnet. The at least one first magnetic piece 101 and the at least one second magnetic piece 201 have opposite polarities. Of course, the at least one second magnetic piece 201 may be a metal that is magnetically attracted (such as iron) or another material that is magnetically attracted. Alternatively, the at least one second magnetic piece 201 maybe a permanent magnet, such as a magnet, and the at least one first magnetic piece 101 may be the metal that is magnetically attracted (such as iron) or another materials that is magnetically attracted.

During an assembling process of the oral irrigator, the magnetic attraction force generated by the at least one first magnetic piece 101 and the at least one second magnetic piece 102 guides the water tank 200 and the main body 100, so the water tank 200 and the main body 100 are automatically positioned and connected without a need for manual alignment by a user, making the assembling process convenient. Moreover, the magnetic attraction force between the at least one first magnetic piece 101 and the at least one second magnetic piece 102 prevents the water tank 200 and the main body 100 from separating, so that the water tank 200 is stably connected to the main body 100.

A sum of a gravity of the water tank 200 and a gravity of a liquid fully filled in the water storage space 208 is always less than the magnetic attraction force, so that the water tank 200 is stably connected to the main body 100. Namely, the water tank 200 and the main body 100 are not separated from each other under an action of gravity through the magnetic attraction force. The gravity of the water tank 200 refers to the gravity of the water tank 200 itself when there is no liquid in the water storage space 202. The gravity of the liquid fully filled in the water storage space 208 refers to the gravity of the liquid fully filled in the water storage space 208 with a maximum capacity.

After the at least one first magnetic piece 101 and the at least one second magnetic piece 201 are aligned, it is ensures that the water tank 200 is stably connected to the main body 100 regardless of whether the water storage space 208 is full of the liquid or not, so as to avoid the water tank 200 and the main 100 from separating under the action of gravity, making the use of the oral irrigator reliable.

Specifically, the gravity of the main body 100 is G1, the sum of the gravity of the water tank 200 and the gravity of the liquid fully filled in the water storage space 208 is G2, and a ratio of G1 to G2 is not less than 0.5 and not greater than 2. Optionally, the ratio of G1 to G2 is 0.5, 0.6, 0.7, 0.8, 0.9, 1, 1.1, 1.2, 1.3, 1.4, 1.5, 1.6, 1.7, 1.8, 1.9 or 2.

The gravity of the water tank 200 and the gravity of the main body 100 generally do not change or change slightly, so when the ratio of G1 to G2 is less than 0.5, an amount of the liquid allowed to be stored in the water storage space 208 is small. As a result, each time the water storage space 208 is filled with the liquid, the liquid is quickly ran out, and the user needs to repeatedly replenish the liquid into the water tank 200, which affects the user experience. When the ratio of G1 to G2 is greater than 2, G2 is large, and the amount of the liquid allowed to be stored in the water storage space 208 is large. Therefore, a larger magnetic attraction force is required between the at least one first magnetic piece 101 and the at least one second magnetic piece 201 to ensure a stable connection between the water tank 200 and the main body 100, which increases a volume of the at least one first magnetic piece 101 and a volume of the at least one second magnetic piece 201, reduce a distance between the at least one first magnetic piece 101 and the at least one second magnetic piece 201, affect a material selection of the at least one first magnetic piece 101 and the at least one second magnetic piece 2011, affects a layout of the oral irrigator 1, and increases costs.

When the water tank 200 is connected to the one side of the main body 100 facing the water tank 200, the water tank 200 is connected to the main body 100 at least by the magnetic attraction force. That is, the water tank 200 and the main body 100 may be connected only by the magnetic attraction force, or the water tank 200 and the main body 100 are not only connected by the magnetic attraction force, but there are other forces between the water tank 200 and the main body 100 to maintain the relative position between the water tank 200 and the main body 100. Since the magnetic attraction force is provided, even if there are other forces, the other forces are reduced to a certain extent. Implementation methods of the other forces are more flexible, making structural methods of the oral irrigator 1 more diverse, which is conducive to improving applicability of the oral irrigator 1 and reducing the costs.

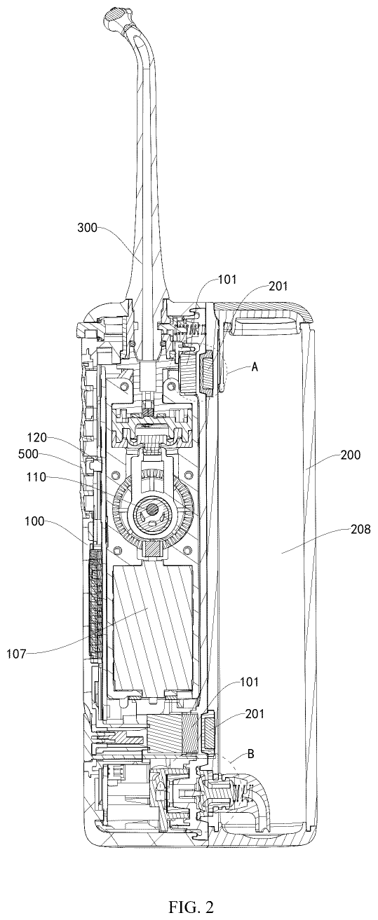

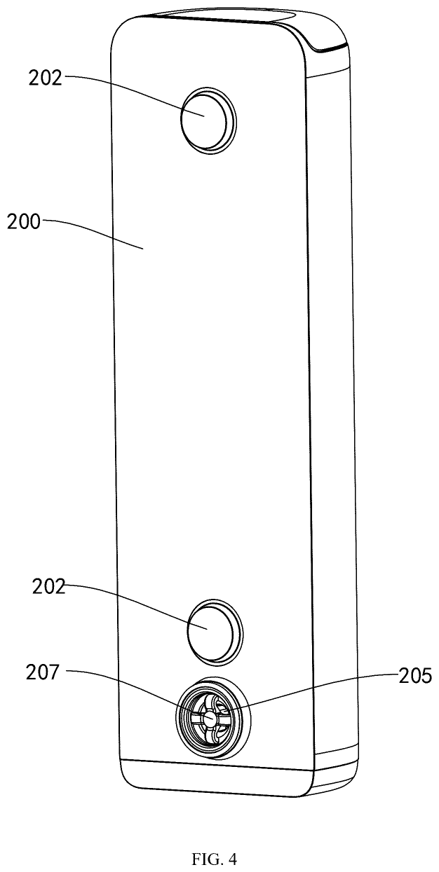

As shown in FIGS. 2, 4, and 7, in some embodiments, the one side of the main body 100 facing the water tank 200 is a first flat surface. The at least one first magnetic piece 101 is disposed on the one side of the main body 100 facing the water tank 200. One side of the water tank 200 facing the main body 100 is a second flat surface. The at least one second magnetic piece 201 is disposed on the one side of the water tank 200 facing the main body 100. The one side of the main body 100 facing the water tank 200 is attached to the one side of the water tank 200 facing the main body 100.

In other embodiments, the one side of the main body 100 facing the water tank 200 is a first curved surface. The at least one first magnetic piece 101 is disposed on the one side of the main body 100 facing the water tank 200. The one side of the water tank 200 facing the main body 100 is a second curved surface. The at least one second magnetic piece 201 is disposed on the one side of the water tank 200 facing the main body 100. The one side of the main body 100 facing the water tank 200 is attached to the one side of the water tank 200 facing the main body 100.

In this way, on the one hand, the distance between the at least one first magnetic piece 101 and the at least one second magnetic piece 201 is closer, increasing the magnetic attraction force between the at least one first magnetic piece 101 and the at least one second magnetic piece 201, and improving a connection strength between the water tank 200 and the main body 100. Therefore, the relative position between the water tank 200 and the main body 100 is more reliable and the water tank 200 and the main body 100 are not easy to separate. On the other hand, a shape of the one side of the main body 100 facing the water tank 200 is matched with a shape of the one side of the water tank 200 facing the main body 100, so the main body 100 and the water tank 200 are closely fitted to each other, reducing a gap between the main body 100 and the water tank 200, reducing a volume of the oral irrigator 1, and reducing a probability of liquid leakage.

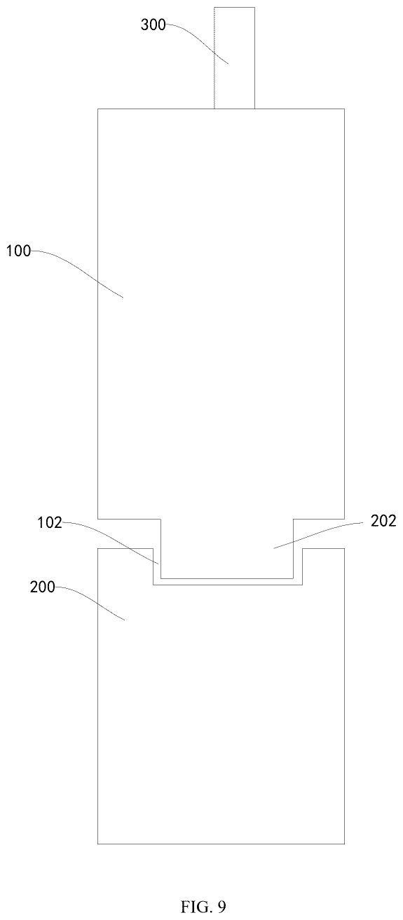

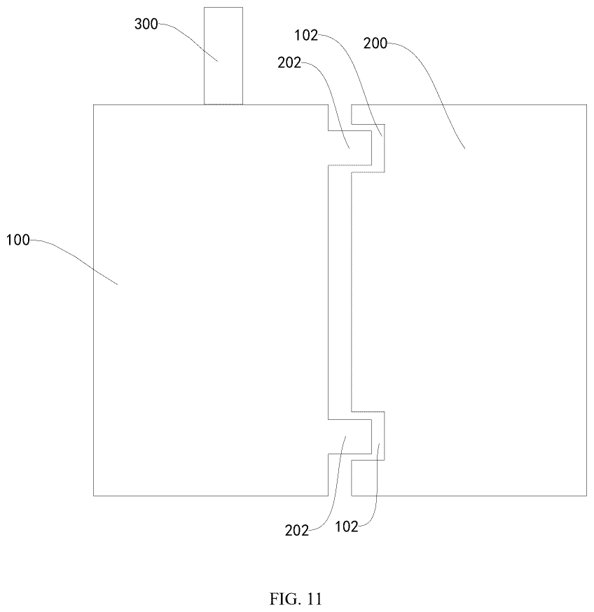

As shown in FIGS. 9 and 11, at least one protrusion 202 is disposed on one of the main body 100 and the water tank 200. At least one recess 102 is defined in the other one of the main body 100 and the water tank 200. The at least one protrusion 202 is engaged with the at least one recess 102. In this way, construction methods of the main body 100 and the water tank 200 are more diverse, thereby increasing the structural flexibility of the oral irrigator 1.

Since the main body 100 and the water tank 200 are connected to each other through the at least one protrusion 202 and the at least one recess 102, it is easy to position the main body 100 and the water tank 200, thereby shortening an installation time between the main body 100 and the water tank 200, improving production efficiency, facilitating assembly, and providing a better user experience during use.

Specifically, when the one side of the main body 100 facing the water tank 200 is connected to the water tank 200, the at least one protrusion 202 and the at least one recess 102 play a supporting role to prevent the main body 100 and the water tank 200 from being misplaced in a length direction of the oral irrigator 1. When the end portion of the main body 100 is connected to the water tank 200, the at least one protrusion 202 and the at least one recess 102 play a position limiting role to prevent the main body 100 and the water tank 200 from being misplaced in a radial direction of the oral irrigator 1.

As shown in FIG. 1, an outer surface of the water tank 200 and an outer surface of the main body 100 are smoothly transitioned. In this way, no step structure is formed between the water tank 200 and the main body 100. On the one hand, the hand feeling of the oral irrigator 1 is optimized, making the oral irrigator 1 fit a palm closely and avoiding the palm from being suspended. On the other hand, a connecting position between the water tank 200 and the main body 100 is easy to clean and is not prone to dirt and dust accumulation, which makes cleaning of the oral irrigator 1 simple.

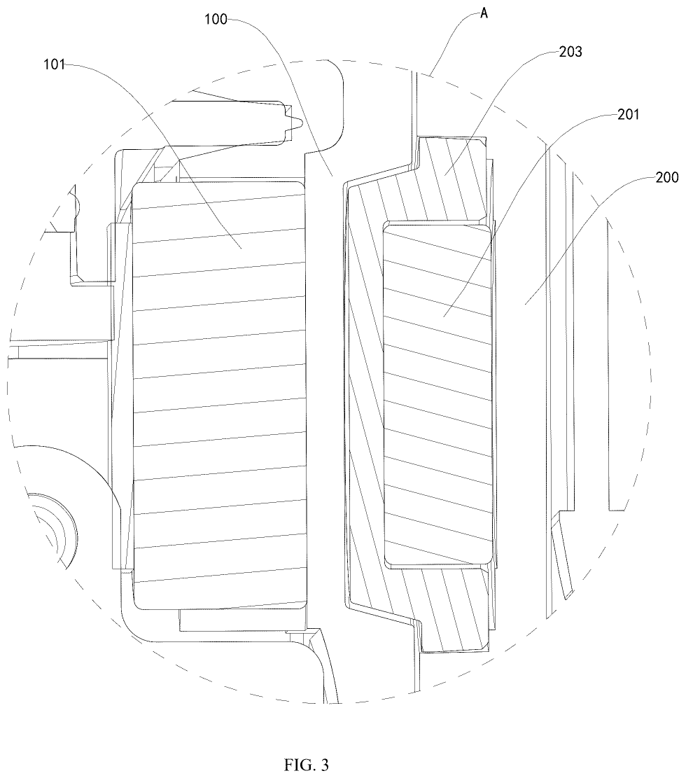

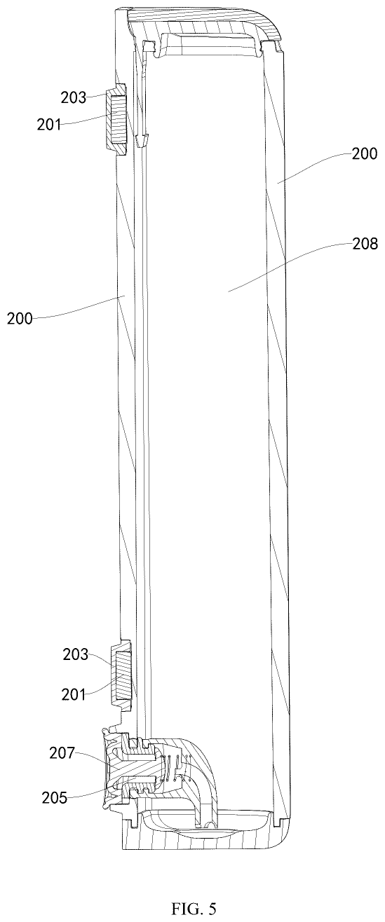

As shown in FIGS. 3 and 5, areas of cross sections of the at least one protrusion 202 gradually decrease toward a direction approaching the at least one recess 102.

The at least one protrusion 202 may in a truncated cone shape or a square cone shape, so that an area of a topmost cross section of the at least one protrusion 202 is minimized. A structure of the at least one protrusion 202 well guide an installation thereof, so that the at least one protrusion 202 is more easily inserted into the at least one recess 102, thereby improving the installation efficiency between the water tank 200 and the main body 100.

As shown in FIGS. 2 and 5, the at least one protrusion 202 comprises a first protrusion and a second protrusion. The at least one recess 102 comprises a first recess and a second recess. The first protrusion is engaged with the first recess, and the second protrusion is engaged with the second recess. Before the second protrusion is engaged with the second recess, the first protrusion is engaged with the first recess.

Accordingly, the at least one first magnetic piece comprises first magnetic pieces 101, and the at least one second magnetic piece 201 comprises second magnetic pieces 201. Therefore, a first one of the first magnetic pieces 101 and a first one of the second magnetic pieces 201 that are respectively disposed at the first protrusion 101 and the first recess are magnetically connected first, providing a driving force for subsequent connection between the second protrusions 202 and the second recess 102. The subsequent connection between the second protrusions 202 and the second recess 102 is faster, thereby improving the installation efficiency between the water tank 200 and the main body 100.

Alternatively, as shown in FIGS. 2 and 5, the at least one protrusion 202 comprises protrusions 202. The at least one recess 102 comprises recesses 102. The protrusions 202 are one-to-one engaged with the recesses 102. When the water tank 200 is connected to the one side of the main body 100 facing the water tank 200, the protrusions 202 are disposed at intervals along the length direction of the oral irrigator 1. A distance between an uppermost protrusion 202 and a top end of the water tank 200 is less than a distance between the uppermost protrusion 202 and a middle portion of the water tank 200. A distance between a lowermost protrusion 202 and a bottom end of the water tank 200 is less than a distance between the lowermost protrusion 202 and the middle portion of the water tank 200.

In this way, the uppermost protrusion 202 is closer to the top end of the water tank 200, and the lowermost protrusion 202 is closer to the bottom end of the water tank 200. The magnetic attraction forces between the water tank 200 and the main body 100 acts on the top end and the bottom end of the water tank 200, thereby preventing the water tank 200 from rotating relative to the main body 100, and making the relative position between the water tank 200 and the main body 100 more stable.

Specifically, the protrusions 202 are disposed on the main body 100, and the recesses 102 are defined in the water tank 200. The first magnetic pieces are respectively disposed on the protrusions, and the second magnetic pieces are respectively disposed on the recesses. Alternatively, the recesses 102 are defined in the main body 100, the protrusions 202 are disposed on the water tank 200, the first magnetic pieces 101 are respectively disposed on the recesses 102, and the second magnetic pieces are disposed on the protrusions 202.

Since the protrusions 202 are one-to-one engaged with the recesses 102, accurate positioning between the first magnetic pieces 101 and the second magnetic pieces 201 is realized, thereby improving the positioning accuracy between the first magnetic pieces 101 and the second magnetic pieces 201 and ensuring that the magnetic attraction forces between the first magnetic pieces 101 and the second magnetic pieces 201 is relatively large. Therefore, the connection between the main body 100 and the water tank 200 is stable and reliable.

The main body 100 is connected to first covers (not shown in the drawings). Each of the first magnetic pieces is disposed between a corresponding one of the first covers and the main body 100. The first covers protrude relative to the outer surface of the main body 100. The water tank 200 accordingly defines the recesses matched with the first covers.

Since the first covers and the main body 100 are separated structures, the first magnetic pieces 101 are first fixed to the first covers or to the main body 100, and then the first covers and the main body 100 are connected. A fixing method of the first magnetic pieces 101 is simpler, and the first covers form the protrusions 202, so there is no need to dispose additional raised structures on the main body 100. The first covers integrate two functions, reduce the number of parts, and improve production efficiency.

Furthermore, first mounting grooves (not shown in the drawings) are defined in the outer surface of the main body 100. A first portion of each of the first magnetic pieces is disposed in a corresponding one of the first mounting grooves, and a second portion of each of the first magnetic pieces is disposed outside the first mounting grooves and is shielded by the corresponding one of the first covers.

By providing the first mounting grooves, on the one hand, the main body 100 and the first magnetic pieces 101 are pre-positioned, and then the first covers are connected to the main body 100 to realize the assembly of the main body 100, and a relative position between the main body 100 and the first magnetic pieces 101 is more stable. On the other hand, a size of the second portion of each of the first magnetic pieces 101 protruding from the main body 100 is reduced, thereby reducing a size of each of the first covers protruding from the main body 100 and reducing the costs.

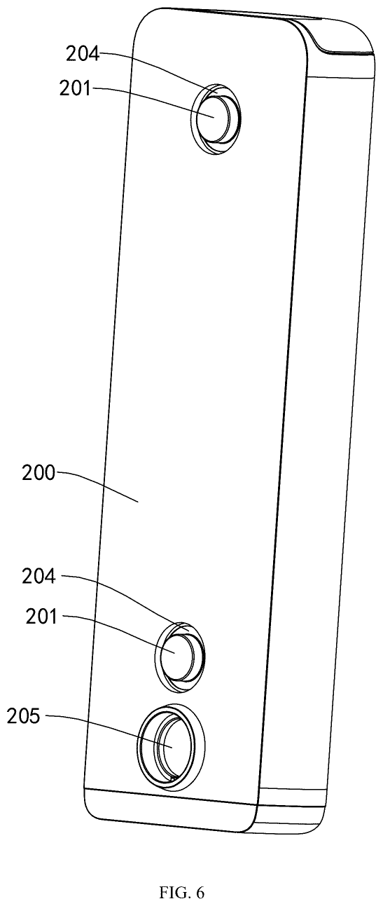

As shown in FIGS. 5 and 6, the water tank 200 is connected to second covers 203. The second magnetic pieces 201 are disposed between a corresponding one of the second covers 203 and the water tank 200, and the second covers 203 protrude relative to the outer surface of the water tank 200. The main body 100 accordingly defines the recesses 102 matched with the second covers 203.

Since the second covers 203 and the water tank 200 are separated structures, the second magnetic pieces 201 are first fixed to the second covers 203 or to the water tank 200, and then the second covers 203 and the water tank 200 are connected. A fixing method of the second magnetic pieces 201 is simpler, and the second covers 203 form the protrusions 202, so there is no need to dispose additional raised structures on the water tank 200. The second covers 203 integrate two functions, reduce the number of parts, and improve production efficiency.

Furthermore, second mounting grooves 204 are defined in the outer surface of the water tank 200. A first portion of each of the second magnetic pieces 201 is disposed in a corresponding one of the second mounting grooves 204, and a second portion of each of the second magnetic pieces 201 is disposed outside the second mounting grooves 204 and is shielded by the corresponding one of the second covers 203. By providing the second mounting grooves 204, on the one hand, the water tank 200 and the second magnetic pieces 201 are pre-positioned, and then the second covers 203 are connected to the water tank 200 to realize the assembly of the water tank 200, and a relative position between the water tank 200 and the second magnetic pieces 201 is more stable. On the other hand, a size of the second portion of each of the second magnetic pieces 201 protruding from the water tank 200 is reduced, thereby reducing a size of each of the second covers 203 protruding from the water tank 200 and reducing the costs.

The water tank 200 is movable between a first position and a second position relative to the main body 100. When the water tank 200 is in the first position, the water storage space 208 has a first volume, and a first distance is defined between each of the first magnetic pieces 101 and a corresponding one of the second magnetic pieces 201. When the water tank 200 is in the second position, the water storage space 208 has a second volume, and a second distance is defined between each of the first magnetic pieces 101 and the corresponding one of the second magnetic pieces 201. The first volume is greater than the second volume. The first distance is less than the second distance.

When the oral irrigator 1 is in use, the water tank 200 is in the first position to enable the water storage space 208 to have a larger volume to store more liquid, and the oral irrigator 1 is allowed to be used for a longer time after each replenishment of the liquid. When the oral irrigator 1 is not in use and is stored, the water tank 200 is in the second position to enable the water storage space 208 to have a smaller volume, so the oral irrigator 1 is smaller in size for storage and carrying.

When the water tank 200 is in the first position, the first distance between each of the first magnetic pieces 101 and the corresponding one of the second magnetic pieces 201 is less than the second distance, so the magnetic attraction forces between the first magnetic piece 101 and the second magnetic pieces 201 is greater than that of a case where the water tank 200 is in the second position, the connection between the water tank 200 and the main body 100 is more stable, and the water storage space 208 is allowed to store more liquid.

Furthermore, when the water tank 200 is in the second position, the outer surface of the water tank 200 and the outer surface of the main body 100 are smoothly transitioned. In this way, when the water tank 200 is in the second position, no step structure is formed between the water tank 200 and the main body 100. On the one hand, the hand feeling of the oral irrigator 1 is optimized, making the oral irrigator 1 fit the palm closely and avoiding the palm from being suspended. On the other hand, the connecting position between the water tank 200 and the main body 100 is easy to clean and is not prone to dirt and dust accumulation, which makes cleaning of the oral irrigator 1 simple.

As shown in FIG. 3, a distance between each of the first magnetic pieces 101 and the corresponding one of the second magnetic pieces 201 is not greater than 3 mm. Optionally, the distance between each of the first magnetic pieces 101 and the corresponding one of the second magnetic pieces 201 may be 0.5 mm, 1 mm, 1.5 mm, 2 mm, 2.5 mm or 3 mm, which is not limited thereto.

In this way, the distance between each of the first magnetic pieces 101 and the corresponding one of the second magnetic pieces 201 is small, and the magnetic attraction forces between the first magnetic pieces 101 and the second magnetic pieces 201 are large, ensuring that the magnetic attraction forces between the first magnetic pieces 101 and the second magnetic pieces 201 are sufficient. Therefore, relative movement between the water tank 200 and the main body 100 is effectively avoided, and the relative position between the water tank 200 and the main body 100 is kept.

As shown in FIGS. 2 and 5, the relative position between the main body and the water tank is predetermined. The at least one first magnetic piece comprises the first magnetic pieces, and the first magnetic pieces are disposed at intervals. The at least one second magnetic piece comprises second magnetic pieces, and the second magnetic pieces are disposed at intervals. The second magnetic pieces are one-to-one magnetically attracted to the first magnetic pieces, and the magnetic attraction forces between the first magnetic pieces and the second magnetic pieces keep the relative position between the main body and the water tank being unchanged.

In this way, the magnetic attraction forces between the first magnetic pieces 101 and the second magnetic pieces 201 as a whole form a guiding force between the main body 100 and the water tank 200, which guides the user to assemble the oral irrigator 1, so that the relative position between main body 100 and the water tank 200 is kept unchanged after installation, avoiding reverse installation, wrong installation, etc. There is no need to position the water tank 200 and the main body 100 by manual alignment, and assembly thereof is more convenient.

As shown in FIG. 2, the main body comprises a motor 107, and the motor 107 is disposed in at least one of following four ways.

In a first way, at least part of each of the first magnetic pieces 101 is staggered with the motor 107 in the length direction of the oral irrigator 1.

In a second way, at least part of each of the second magnetic pieces 201 is staggered with the motor 107 in the length direction of the oral irrigator 1.

In a third way, on a plane perpendicular to an axial direction of the oral irrigator 1, at least part of an orthographic projection of each of the first magnetic pieces is staggered with an orthographic projection of the motor 107.

In a fourth way, on the plane perpendicular to the axial direction of the oral irrigator 1, at least part of an orthographic projection of each of the second magnetic pieces is staggered with the orthographic projection of the motor 107.

In this way, the first magnetic pieces 101 and the second magnetic pieces 201 are staggered with the motor 107, reducing interference of the first magnetic pieces 101 and the second magnetic pieces 201 on an internal magnet of the motor 107, avoiding power decline of the motor 107, ensuring a normal use of the motor 107, and prolonging service life of the motor 107.

As shown in FIG. 2, the arrangement of the oral irrigator 1 is selected from at least one of following three arrangements.

In a first arrangement, the first magnetic pieces 101 are disposed inside the main body 100.

In a second arrangement, the main body 100 comprises a housing, and the first magnetic pieces 101 are disposed inside a wall of the housing.

In a third arrangement, the water tank 200 comprises a water tank shell, and the second magnetic pieces 201 are disposed inside a wall of the water tank shell. The water tank shell comprises the second covers 203.

In this way, the first magnetic pieces 101 are not exposed to an external space of the main body 100, which reduces a probability of the first magnetic pieces 101 contacting air and prevents the first magnetic pieces 101 from being corroded when an external humidity of the main body 100 is high, thereby avoiding the first magnetic pieces 101 from rusting and bumping, reducing a probability of damage to the first magnetic pieces 101, and prolonging service life of the first magnetic pieces 101. Similarly, the second magnetic pieces 201 are not exposed to the external space of the water tank 200, which reduces a probability of the second magnetic pieces 201 contacting air and prevents the second magnetic pieces 201 from being corroded when the external humidity and an internal temperature of the water tank 200 are high, thereby avoiding the second magnetic pieces 201 from rusting and bumping, reducing a probability of damage to the second magnetic pieces 201, and prolonging service life of the second magnetic pieces 201.

As shown in FIGS. 1 and 2, when the water tank 200 is connected to the one side of the main body 100 facing the water tank 200, at least one of an operation module 500 and a display module is disposed on one side of the main body 100 away from the water tank 200. The operation module 500 may be a touch screen, a button, a sliding key, a rocker, etc., and the display module may be a display panel, a touch screen, etc.

In this way, when the user operates the operation module 500 or the display module, pressure is applied to the main body 100 from the one side of the main body 100 away from the water tank 200, so the main body 100 moves approaching the water tank 200. Thus, the main body 100 and the water tank 200 are not separated by the pressure, thereby avoiding misalignment between the main body 100 and the water tank 200 due to the pressure.

The water tank 200 comprises connecting structures (not shown in the drawings), and the connecting structures are connected to the main body 100. Alternatively, the main body 100 comprises the connecting structures, and the connecting structures are connected to the water tank 200. Alternatively, both the water tank 200 and the main body 100 comprises the connecting structures to be connected to each other. The connecting structures may be buckles, snappers, Velcro, restraint belts, etc.

In this way, in addition to the magnetic attraction forces, the water tank 200 and the main body 100 are further connected by other connecting forces. The connecting forces between the water tank 200 and the main body 100 are large, making the connection between the water tank 200 and the main body 100 more stable. The relative position between the water tank 200 and the main body 100 is not changed. Moreover, the magnetic attraction forces further guide the connection of the connecting structures, which facilitate the connection of the connecting structures and improve the assembly efficiency and ease of use of the oral irrigator 1.

A buffer pad is disposed between the main body 100 and the water tank 200 to fill the gap between the main body 100 and the water tank 200. The buffer pad may be made from sponge, rubber, or silicone. By providing the buffer pad, on the one hand, a friction between the main body 100 and the water tank 200 is increased to ensure the relative position between the main body 100 and the water tank 200 being unchanged, on the other hand, the gap between the main body 100 and the water tank 200 is filled to avoid relative shaking between the main body 100 and the water tank 200. The buffer pad further absorbs noise caused by collision between the water tank 200 and the main body 100 to optimize the user experience of the oral irrigator 1.

When the water tank 200 is connected to the end portion of the main body 100, a portion of the water tank 200 is located on the one side of the main body 100 facing the water tank 200 in the radial direction of the main body 100. Structures such as a battery, a control circuit board 120, and a pump body 110, must be disposed inside the main body 100. By configuring the portion of the water tank 200 on the one side of the main body 100 facing the water tank 200, a gravity center of the water tank 200 is closer to a nozzle 300, so energy required to pump the liquid in the water tank 200 to the nozzle 300 and then squirt the liquid out is relatively small, which saves energy and improve an endurance of the oral irrigator 1. Moreover, a length of the oral irrigator 1 is allowed to be reduced accordingly, and a gravity center of the oral irrigator 1 is lowered, which improves the stability of the oral irrigator 1 when placed, and reduces a probability of the oral irrigator 1 tipping over.

As shown in FIGS. 1 and 2, when the water tank 200 is connected to one side of the main body 100, the bottom end of the water tank 200 is flush with a bottom end of the main body 100, and the top end of the water tank 200 is flush with a top end of the main body 100. In this way, the gravity center of the water tank 200 is closer to the nozzle 300, and the energy required to pump the liquid in the water tank 200 to the nozzle 300 and squirt the liquid out is relatively small, which saves energy and improve the endurance of the oral irrigator 1. Moreover, the length of the oral irrigator 1 is allowed to be reduced accordingly, and the gravity center of the oral irrigator 1 is lowered, which improves the stability of the oral irrigator 1 when placed, and reduces the probability of the oral irrigator 1 tipping over.

As shown in FIGS. 2 and 4-7, the main body 100 is detachably connected to the water tank 200. The main body 100 comprises a first communicating opening 105. The water tank 200 comprises a second communicating opening 205. The first communicating opening 105 is connected to the pump 110 disposed in the main body 100. A valve 207 is disposed at the second communicating opening 205. When the water tank 200 is connected to the main body 100, the valve 207 is opened, and the first communicating opening 105 is communicated with the second communicating opening 205. When the water tank 200 is separated from the main body 100, the valve 207 is closed, and the first communicating opening 105 is not communicated with the second communicating opening 205.

The liquid is allowed to be added into the water tank 200 when the main body 100 is connected to the water tank 200, and the liquid is also allowed to be added into the water tank 200 when the main body 100 is separated from the water tank 200, so the use has more diverse and flexible ways to add the liquid. Further, the main body 100 and the water tank 200 are separate structures, which are convenient for carrying.

When the main body 100 and the water tank 200 are connected, since the valve 207 is open, the liquid in the water tank 200 flows to the nozzle 300 through the second communicating opening 205 and the first communicating opening 105. When the main body 100 and the water tank 200 are separated, since the valve 207 is closed, the liquid in the water tank 200 does not leak through the second communicating opening 205, which is conducive to carrying the water tank 200 separately and replenishing the liquid in the water tank 200.

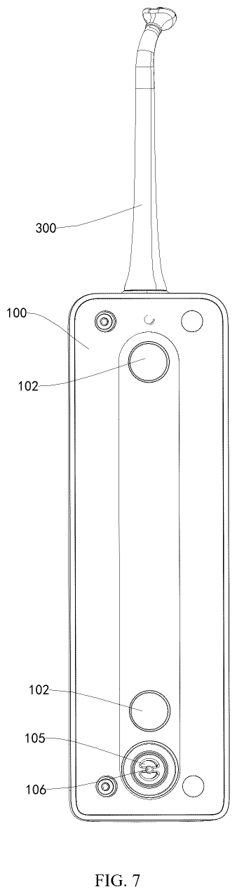

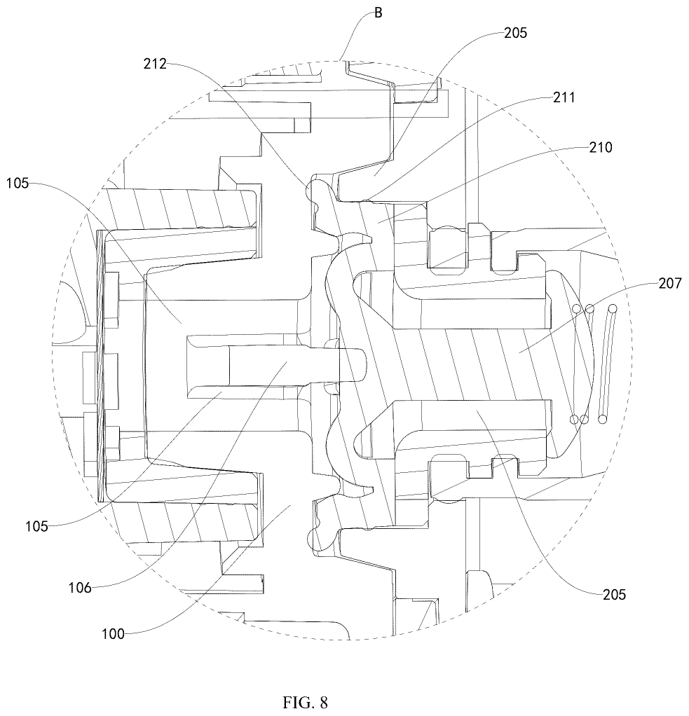

As shown in FIGS. 7 and 8, an abutting piece 106 is disposed at the first communicating opening 105. When the water tank 200 is connected to the main body 100, the abutting piece 106 abuts against the valve 207 to open the valve 207. For instance, when the water tank 200 is connected to the one side of the main body 100 facing the water tank, the magnetic attraction forces generated between the first magnetic pieces 101 and the second magnetic pieces 201 drives the abutting piece 106 to open the valve 207. When the water tank 200 is connected to the end portion of the main body 100, the magnetic attraction forces generated between the first magnetic pieces 101 and the second magnetic pieces 201 and the gravity of the main body 100 drive the abutting piece 106 to open the valve 207. After the water tank 200 and the main body 100 are separated, the valve 207 is reset to close the second communicating opening 205.

In this way, a switching between open and close of the valve 207 is directly linked to separation and connection between the water tank 200 and the main body 100, so that sealing performance of the valve 207 on the second communicating opening 205 is ensured when the water tank 200 and the main body 100 are separated. In addition, the second communicating opening 205 is ensured to be open when the water tank 200 and the main body 100 are connected, so that the second communicating opening 205 is communicated with the first communicating opening 105, thereby facilitating the normal use of the oral irrigator 1 and ensuring replenishing of liquid in the water tank 200 separately.

As shown in FIGS. 2, 5, and 6, when the water tank 200 is connected to one side of the main body 100 facing the water tank 200, the first communicating opening 105 is defined in the bottom end of the main body 100, and the second communicating opening 205 is defined in the bottom end of the water tank 200. In this way, a distance between the second communicating opening 205 and a bottom wall of the water storage space 208 is short, a water pipe between the second communicating opening 205 and the bottom wall of the water storage space 208 is shortened, and less liquid remains in the water storage space 208. Moreover, a distance between the first communicating opening 105 and the second communicating opening 205 is short, so that the first communicating opening 105 is allowed to be communicated with the second communicating opening 205 without any additionally communication structure, making the structure of the oral irrigator 1 simple.

As shown in FIGS. 2 and 8, the oral irrigator 1 further comprises a sealing piece 210. A first sealing protrusion 211 is disposed on an outer circumference of the sealing piece 210. A second sealing protrusion 212 is disposed on an end portion of the sealing piece 210. The first sealing protrusion 211 contacts an inner circumferential surface of the first communicating opening 105, and the second sealing protrusion 212 abuts against the one side of the water tank 200 facing the main body 100. Alternatively, the first sealing protrusion 211 contacts an inner circumferential surface of the second communicating opening 205, and the second sealing protrusion 212 abuts against the one side of the main body 100 facing the water tank 200.

Namely, the first sealing protrusion 211 contacts the inner circumferential surface of the first communicating opening 105 or the inner circumferential surface of the second communicating opening 205 to seal the first communicating opening 105 and the second communicating opening 205 in the axial direction, which avoids leakage of the liquid from the second communicating opening 205 in the axial direction. The second sealing protrusion 212 contacts the one side of the water tank 200 facing the main body 100 or the one side of the main body 100 facing the water tank 200 to seal the first communicating opening 105 and the second communicating opening 205 in the radial direction, which avoids leakage of the liquid from the second communicating opening 205 in the radial direction.

In this way, the sealing piece 210 realizes a double sealing effect. Moreover, the first communicating opening 105 and the second communicating opening 205 are sealed from different directions, so the sealing effect is better and a risk of liquid leakage is greatly reduced.

What is claimed is:

1. An oral irrigator, comprising:
a main body; and
a water tank connected to the main body;
wherein at least one first magnetic piece is disposed on the main body, the water tank defines a water storage space or the water tank and the main body jointly define the water storage space, at least one second magnetic piece is disposed on the water tank, and the at least one first magnetic piece is magnetically connected to the at least one second magnetic piece to generate a magnetic attraction force;
wherein a sum of a gravity of the water tank and a gravity of a liquid fully filled in the water storage space is less than the magnetic attraction force, and the water tank and the main body are not separated from each other under an action of gravity through the magnetic attraction force.

2. The oral irrigator according to claim 1, wherein one side of the main body facing the water tank is a first flat surface, the at least one first magnetic piece is disposed on the one side of the main body facing the water tank, one side of the water tank facing the main body is a second flat surface, the at least one second magnetic piece is disposed on the one side of the water tank facing the main body, and the one side of the main body facing the water tank is attached to the one side of the water tank facing the main body; or
the one side of the main body facing the water tank is a first curved surface, the at least one first magnetic piece is disposed on the one side of the main body facing the water tank, the one side of the water tank facing the main body is a second curved surface, the at least one second magnetic piece is disposed on the one side of the water tank facing the main body, and the one side of the main body facing the water tank is attached to the one side of the water tank facing the main body.

3. The oral irrigator according to claim 1, wherein an outer surface of the water tank and an outer surface of the main body are smoothly transitioned.

4. The oral irrigator according to claim 1, wherein at least one protrusion is disposed on one of the main body and the water tank; at least one recess is defined in the other one of the main body and the water tank; the at least one protrusion is engaged with the at least one recess.

5. The oral irrigator according to claim 4, wherein areas of cross sections of the at least one protrusion gradually decrease toward a direction approaching the at least one recess.

6. The oral irrigator according to claim 4, wherein the at least one protrusion comprises a first protrusion and a second protrusion, the at least one recess comprises a first recess and a second recess, the first protrusion is engaged with the first recess, and the second protrusion is engaged with the second recess;
wherein before the second protrusion is engaged with the second recess, the first protrusion is engaged with the first recess.

7. The oral irrigator according to claim 4, wherein the at least one protrusion comprises protrusions, the at least one recess comprises recesses, and the protrusions are one-to-one engaged with the recesses;
wherein when the water tank is connected to one side of the main body, the protrusions are disposed at intervals along a length direction of the oral irrigator, wherein a distance between an uppermost protrusion and a top end of the water tank is less than a distance between the uppermost protrusion and a middle portion of the water tank, and a distance between a lowermost protrusion and a bottom end of the water tank is less than a distance between the lowermost protrusion and the middle portion of the water tank.

8. The oral irrigator according to claim 4, wherein the at least one protrusion is disposed on the main body, the at least one recess is defined in the water tank, the at least one first magnetic piece is disposed on the at least one protrusion, and the at least one second magnetic piece is disposed on the at least one recess; or
the at least one recess is defined in the main body, the at least one protrusion is disposed on the water tank, the at least one first magnetic piece is disposed on the at least one recess, and the at least one second magnetic piece is disposed on the at least one protrusion.

9. The oral irrigator according to claim 1, wherein the main body is connected to at least one first cover, the at least one first magnetic piece is disposed between the at least one first cover and the main body, and the at least one first cover protrudes relative to an outer surface of the main body; and/or
the water tank is connected to at least one second cover, the at least one second magnetic piece is disposed between the at least one second cover and the water tank, and the at least one second cover protrudes relative to an outer surface of the water tank.

10. The oral irrigator according to claim 9, wherein when the main body is connected to the at least one first cover, at least one first mounting groove is defined in the outer surface of the main body, a first portion of the at least one first magnetic piece is disposed in the at least one first mounting groove, and a second portion of the at least one first magnetic piece is disposed outside the at least one first mounting groove and is shielded by the at least one first cover;
wherein when the water tank is connected to the at least one second cover, at least one second mounting groove is defined in the outer surface of the water tank, a first portion of the at least one second magnetic piece is disposed in the at least one second mounting groove, and a second portion of the at least one second magnetic piece is disposed outside the at least one second mounting groove and is shielded by the at least one second cover.

11. The oral irrigator according to claim 1, wherein the water tank is movable between a first position and a second position relative to the main body;
wherein when the water tank is in the first position, the water storage space has a first volume, and a first distance is defined between the at least one first magnetic piece and the at least one second magnetic piece; when the water tank is in the second position, the water storage space has a second volume, and a second distance is defined between the at least one first magnetic piece and the at least one second magnetic piece; the first volume is greater than the second volume, and the first distance is less than the second distance.

12. The oral irrigator according to claim 1, wherein a distance between the at least one first magnetic piece and the at least one second magnetic piece is not greater than 3 mm.

13. The oral irrigator according to claim 1, wherein a relative position between the main body and the water tank is predetermined, the at least one first magnetic piece comprises first magnetic pieces, the first magnetic pieces are disposed at intervals, the at least one second magnetic piece comprises second magnetic pieces, the second magnetic pieces are disposed at intervals, the second magnetic pieces are one-to-one magnetically attracted to the first magnetic pieces, and magnetic attraction forces generated between the first magnetic pieces and the second magnetic pieces keep the relative position between the main body and the water tank being unchanged.

14. The oral irrigator according to claim 1, wherein the main body comprises a motor, and the motor is disposed in at least one of following ways:
at least part of the at least one first magnetic piece is staggered with the motor in a length direction of the oral irrigator;
at least part of the at least one second magnetic piece is staggered with the motor in the length direction of the oral irrigator;
on a plane perpendicular to an axial direction of the oral irrigator, at least part of an orthographic projection of the at least one first magnetic piece is staggered with an orthographic projection of the motor;
on the plane perpendicular to the axial direction of the oral irrigator, at least part of an orthographic projection of the at least one second magnetic piece is staggered with the orthographic projection of the motor;

15. The oral irrigator according to claim 1, wherein the main body comprises a motor, when the water tank is connected to an end portion of the main body, the at least one first magnetic piece is disposed at one end of the main body facing the water tank, and in a length direction of the oral irrigator, the motor is spaced apart from the one end of the main body facing the water tank; or
the main body comprises the motor, when the water tank is connected to one side of the main body facing the water tank, the at least one first magnetic piece is disposed on the one side of the main body facing the water tank, and in a radial direction of the oral irrigator, the motor is spaced apart from the one side of the main body facing the water tank.

16. The oral irrigator according to claim 1, wherein when the water tank is connected to an end portion of the main body, a portion of the water tank is located on one side of the main body in a radial direction of the main body.

17. The oral irrigator according to claim 1, wherein the main body is detachably connected to the water tank, the main body comprises a first communicating opening, the water tank comprises a second communicating opening, the first communicating opening is connected to a pump disposed in the main body, and a valve is disposed at the second communicating opening;
wherein when the water tank is connected to the main body, the valve is opened, and the first communicating opening is communicated with the second communicating opening;
wherein when the water tank is separated from the main body, the valve is closed, and the first communicating opening is not communicated with the second communicating opening.

18. The oral irrigator according to claim 17, wherein an abutting piece is disposed at the first communicating opening, and when the water tank is connected to the main body, the abutting piece abuts against the valve to open the valve.

19. The oral irrigator according to claim 1, wherein the gravity of the main body is G1, the sum of the gravity of the water tank and the gravity of the liquid fully filled in the water storage space is G2, and a ratio of G1 to G2 is not less than 0.5 and not greater than 2.

20. An oral irrigator, comprising:
a main body; and
a water tank connected to the main body;
wherein at least one first magnetic piece is disposed on the main body, at least one second magnetic piece is disposed on the water tank, and the at least one first magnetic piece is magnetically connected to the at least one second magnetic piece to generate a magnetic attraction force;
wherein a relative position between the main body and the water tank is predetermined, the magnetic attraction force generated by the at least one first magnetic piece and the at least one second magnetic piece keeps the relative position between the main body and the water tank being unchanged.
